(19) United States
(12) Patent Application Publication
(10) Pub. No.: US 2019/0049915 A1
(43) Pub. Date: Feb. 14, 2019

(54) SYSTEM AND METHOD FOR PROCESSING CONSUMER DATA IN ELECTRICAL GRIDS

(71) Applicant: Daniel Seleme Dora, Novo Hamburgo (BR)

(72) Inventors: Daniel Seleme Dora, Novo Hamburgo (BR); Fabio Arnhold Daneze, Porto Alegre (BR); Matheus Jardim Bernardes, Porto Alegre (BR)

(21) Appl. No.: 16/058,279

(22) Filed: Aug. 8, 2018

Related U.S. Application Data
(60) Provisional application No. 62/542,386, filed on Aug. 8, 2017.

(51) Int. Cl. G05B 19/042; G06Q 50/06

(52) U.S. Cl. CPC G05B 19/0428; G05B 2219/2639; G06Q 50/06

(57) ABSTRACT

A system and method for processing consumer data in electrical grids to allow the analysis of consumer's data in electrical grids, based on the power consumption of the consumer. The system and method also allows the generation of a consumer profile to be integrated in a central system manager. Furthermore, the consumer can also be provided with an electricity generator in such a way that the system and method is also available to integrate the frequency inverters of the consumer's electricity generators in order to consider said data in the processing of data consumer. The system and method is situated in the field of smart grid, solar farm, wind farm and renewable sources.

### CROSS REFERENCE TO RELATED APPLICATIONS

This patent application claims the benefit of and priority on U.S. Provisional Patent Application No. 62/542,386 having a filing date of 8 Aug. 2017.

### BACKGROUND OF THE INVENTION

### Technical Field

The present invention refers to a system and method for processing consumer's data in electrical grids, based on the electricity consumption of the consumer, so that present solution provides the generation of a consumer profile and can redistribute the exceeding electricity generation of the user. The present invention is situated in the field of smart grid, solar farm, wind farm and renewable sources.

### Prior Art

Currently, new sources of absorption electricity are emerging. The advent of photovoltaic panels or wind turbine each day is becoming more common and its use is spreading for general population. But it is not easier to management of electricity generated. Working with electricity is dangerous, if a person who does not have the knowledge about what he/she is doing, this can provoke serious accidents.

Besides the fact of the security, it is hard to make use of energy. The amount of exceeding energy that a person generates hardly is convert to some type of benefit for the generate source.

Nowadays, the consumer does not have access of how his energy is being consumed. He/she does not know if some device is consuming more than it should. It would be great if was possible to know this information, because fixing these devices can guarantee saving more energy, and hence save more money.

The document U.S. Pat. No. 8,588,991 discloses a method and a device for management of active grid element. The grid element are transformed into active grid element following initial registration with the system, wherein active load client are installed in the client residence, the active load client register the energy consume and send it to the energy management system that analyses the data, being able to limit some equipment parameters, in order to save energy. The document does not disclose the data processing for create a consumer profile in order to generate benefits to the consumer or a system to manage the consumer energy generation.

The document US20050116836 discloses a method, apparatus and system for providing power monitoring service to an electric power monitoring service to an electric power consumer at a power consumer site. The document discloses the installation of a plurality of probes on the consumers power distribution and control box, those probes are used to monitoring the power consumption and identify divergences of consume, triggering a message to the consumer informing that some equipment may be damaged, consuming more energy than common. The document requires multiple probes installed in the consumer's house to identify the energy consumption, and it does not generate a consumer profile for generating benefit to the consumer and, furthermore, it does not discloses a system for monitoring the energy generation from a consumer's energy generator.

The document US20080091590 discloses a method and system for financing renewable energy. The document discloses a net meter installed on the consumer residence, this net meter is able to identify consume or generation of energy, wherein the generated measured energy is used to approve financial instruments for determine a loan amount, so that the consumer is able to pay for the renewable generators that he bought. The document only disclose the metering of the hole energy consume, not being able to identify each equipment consume, furthermore it's not disclosed the monitoring the energy generation rate to identify divergences in the generation.

As can be inferred from literature, there are no documents suggesting or anticipating the teachings of the present invention, so that the solution proposed here has novelty and inventive step outside the state of the art.

### BRIEF SUMMARY OF THE INVENTION

The present invention provides system and method for processing consumer data in electrical grids, based on the electricity consumption of the consumer, and it provides a consumer profile to be integrated in a central system manager. Further, the consumer can also be provided with an electricity generator and the present solution is also available to integrate the frequency inverters of the consumer's electricity generators in order to consider said data in the processing of data consumer. Furthermore, it makes easier the absorption of electricity and its distribution, saving the use of an energy that came from pollution or devastating sources, in a way that a simple physical person or a legal one can generate his own energy, and besides that, can trade energy, when he/she has exceeding electricity generated. The present invention brings people together to facilitate this trade of energy.

In a first aspect, the present invention provides a system for processing consumer data in electrical grids comprising:
data collector installed in the electrical grid that perform a monitoring of power consumption/generation on a consumer electrical grid, identifying consume of a consumer equipment and send the consumer data to a central system manager;
the central system manager process the data acquired by the data collector and generate an consumer profile, wherein the consumer profile is used to generate benefits to the consumer.

In a second aspect, the present invention provides a method for processing consumer data in electrical grids, where said electrical grids comprise at least a data collector in communication with a central system manager, wherein said method comprises the steps of:
collecting the consumer data in an electrical grid by the data collector;
sending collected consumer data to the central system manager;
processing collected consumer data, generating a consumer profile.

In a third aspect, the present invention provides a system for operating consumer data in electrical grids comprising:
a micro farm (1) electricity generator;
a data collector comprising:
at least one hardware (2) for data collection; and
at least one software implementation (3) for data collection;
   wherein the at least one software implementation (3) is implemented in the at least one hardware (2);
an information control device (4);
a generation control equipment (5);
a farm (6) electricity generator; and
an access interface (7);
wherein the hardware (2) of the data collector further comprises a module for consume identification and a module for consume control;
wherein the access interface (7) comprises at least one of: a module for user interface; a module for administration of the consumer unity; a module for energy quota; a module for payment; and/or a converter of exceeding electricity in energy credits.

In a fourth aspect, the present invention provides a method for operating consumer data in electrical grids comprising the steps of collecting the consumer data in an electrical grid by the data collector; sending collected consumer data to the central system manager; and processing collected consumer data, generating a consumer profile, wherein said steps are implemented in the system for operating consumer data in electrical grids as previously described.

These and other aspects of the invention will be immediately appreciated by the well versed in the art, and for companies with interests in the product segment and will be described in sufficient detail to be reproduced in the following description.

### BRIEF SUMMARY OF THE INVENTION

This invention presents the following drawings in order to define an exemplary embodiment of the proposed system and method however, without limiting the scope of protection.

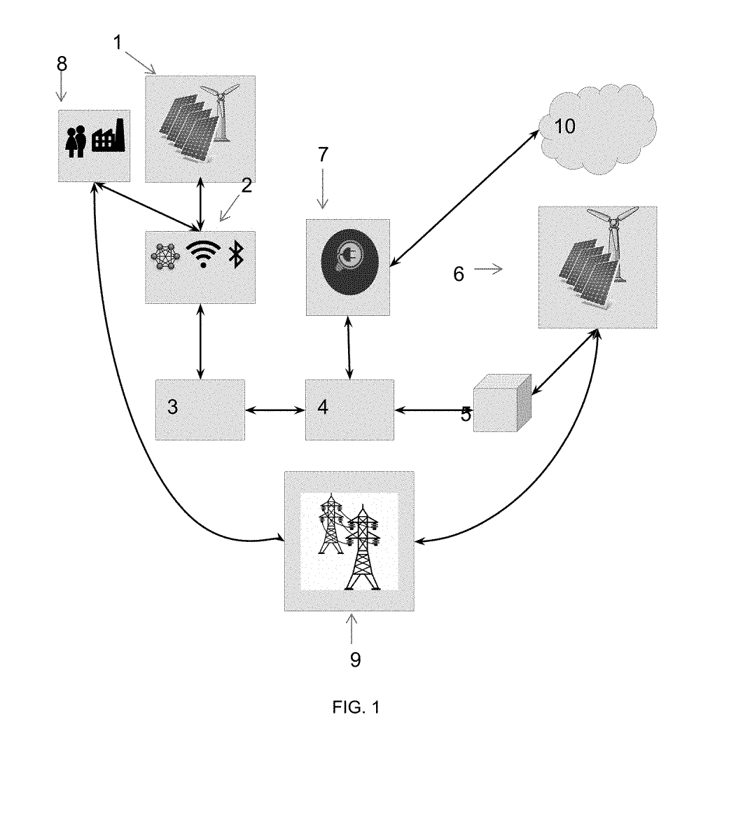

FIG. 1 shows a flowchart of an embodiment of the proposed solution.

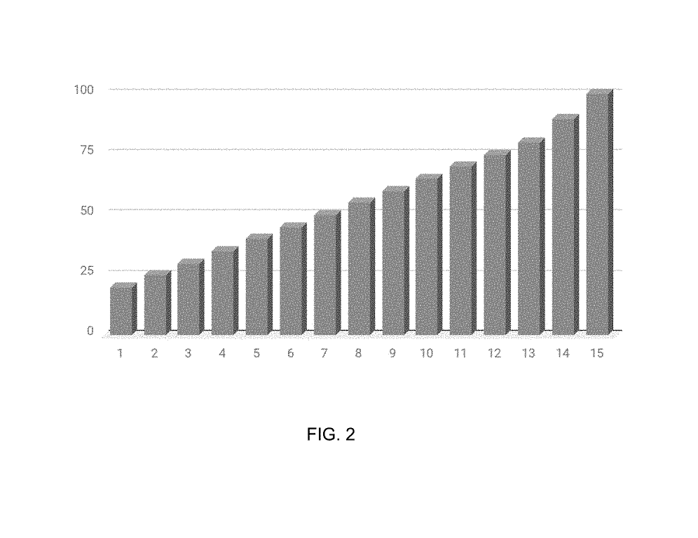

FIG. 2 shows a graph of discount percentage through the years in which the y axis correspond to the discount percentage and the x axis to the years.

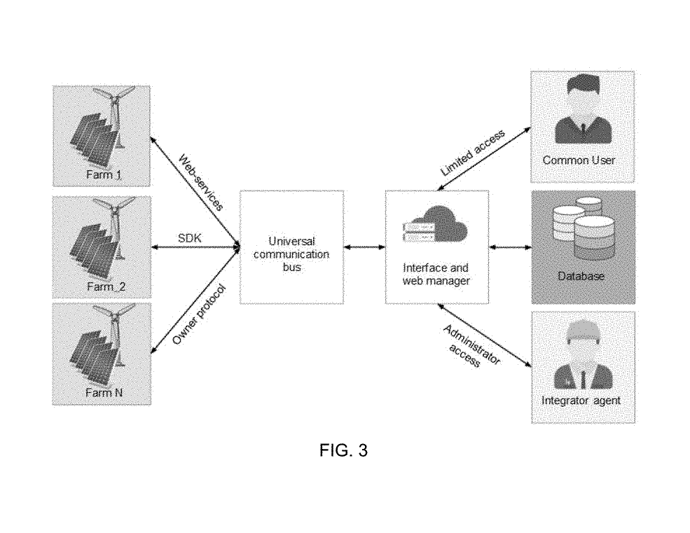

FIG. 3 shows a flowchart of an embodiment of the proposed farm interactions with the present solution.

### DETAILED DESCRIPTION OF PREFERRED EMBODIMENTS

For the present invention, the term “consumer” covers the meaning of an energy user or an energy producer, wherein an energy producer can be a farm or micro farm.

In a first aspect, the present invention provides a system for processing a consumer data in electrical grid, wherein the system comprises a data collector that is installed in the consumer's grid and a central system manager that receives the data collected by the data collector.

The data collector is installed in the consumer electrical grid, and it performs the monitoring of the power consumption/generation of the equipment associated to the electrical grid, being able to identify the consumption/generation of each equipment independently. The collected data is stored and sent to the central system manager. In an embodiment, the data collector is a single hardware provided by software that identifies the consumption/generation of each equipment independently of the consumer. In an embodiment, the data collector comprises a software that analyses the harmonics generated by each equipment of the consumer in the electrical grid.

The central system manager receives the data collected by the data collector and processing it, creating profiles for each consumer, based on the acquired data. These profiles may contain which equipment the consumer most uses and the time of this use. The central system manager also generates benefits for the consumer, based on the acquired data. In some embodiments, the benefits can be discounts on the electric bill or credits that the consumers can use to buy new equipment or services in general.

In one embodiment, the data collector also collects data from at least one electricity generator of any type. In this embodiment, the central system manager, is able to identify the type of the generator and to identify a divergence from an expected generation rate, i.e. a low generating rate, and inform the user, for example, by email, users interface via internet or both, warning the necessity of adjusting the generator parameters.

In another embodiment, the central system manager provide an interface for the user where the user can enter many frequency inverters set up from different manufactures and the user can use the interface to command all of them by a singular command. In another words, the users interface is able to integrate all frequency inverters in a single commander, facilitating the management by the user.

In an embodiment, the database does not have access to the data generated by the software of the integrated manufactures: the data must travel through the universal communication, responsible for the proper translations. Furthermore, the users have access to the data through the interface, common users have limited access to the data, while an integrator agent may access all data and trigger commands against the frequency inverters.

In another embodiment, in view to improve the productivity and minimize rework, all user's interfaces are previously prototyped and documented in a way that all members of the integrator agents has fulltime access.

In an embodiment, the central system manager comprises a scraping algorithm for integrating a plurality of frequency inverters.

In an embodiment, the system is able to distribute/redistribute the energy/exceeding energy generated in micro farms or farms. In an embodiment, micro farms can be a house or a company equipped with devices able to generate electricity from any means, e.g. solar energy, wind energy, etc. For instance, a micro farm is located in urban areas. A farm (6) comprises a place more capable to generate electricity, and can generate more electricity than micro farms. In an embodiment a farm (6) can be a big area covered with solar panels. For example, a farm (6) is located in rural areas.

FIG. 1 shows an example of implementation in a specific electrical grid detailing all the elements and their associations to operate this system.

As proposed in an embodiment of the invention, the micro farm (1) generates electricity, and then it is lead to the data collector, once said device is operably associated with the micro farm (1).

As can be seen, a data collector is operably associated on the consumer electrical grid. The said data collector comprises a hardware (2), which is positioned in a region covered by a power distribution (9), and a software (3) implemented in the hardware (2). The hardware (2), that is, the physical part of the device; it is allocated in the micro farm (1). This hardware (2) is able to management the storage and consume of the micro generation of electricity. Besides, this equipment can recognize the consume signatures, so it can read how the electricity is being consumed in the micro farm (1). Finally, this hardware (2) has the purpose to send this electricity data collected to one software (3) implementation. Therefore, this hardware (2) comprises:
a module for consume identification, that can read data about the electricity that is being consumed;
a module for consume control, that can give the origin of the electricity generation. If it is from a power distribution (9) or propriety generation;
a module for communication, that can send all that data to the software (3) implementation.

In the software (3) implementation, the data can be read by the owner of electrical grid of a user (8), and he/she has access of information about the quality and efficiency of his/her micro generation. After this, the software (3) sends the data collected to an information control device (4).

In the information control device (4), the electricity data collected is consolidated in a database. Further, this device is able to aid operators to make strategy and commercial decisions. Thus, said information control device (4) comprises:
a module for communication, that can gather data from the micro farm (1) and data from patterns of consume from the consumers of electricity. That is, this module communicates with the software(3) implementation;
a module for database. It is able to store the data in a security and confidential way, and at the same time, can generate reports that can help in decision-making. In an embodiment, database is a module data cube;
a module for communication with an access interface (7), this may be any place where data can be managed, and is explained below. At the beginning, the present invention has its own portal that can display the data. But this cannot be a restriction; because this database can be used to any other portals that may eventually need this data;
a module for insight/warning about the deviation in consume and production, able to generate insights and alert the users. This module is able to investigate if some equipment of the micro farm (1) or farm (6) is damaged. That is, if this equipment is wasting more electricity than it should or if there are some problem in the electricity generation. So the system identifies if something is wrong, and stores this information in database.

Referring now to the right-hand side of FIG. 1, where it comprises the farm (6). As explained above, the farm (6) can generate electricity in a bigger dimension than the micro farm (1). After the farm (6) generates its electricity, this one can be collected by a generation control equipment (5). Said equipment works like the data collector, but for the farm (6). So, it has the function of interact with the farm (6), and inform the information control device (4). This generation control equipment (5) is responsible to study the viability of the farm (6), i.e., investigate whether this farm (6) belongs to a place near the power distribution (9) and can generate the determined amount of electricity. The generation control equipment (5) comprises:
a module for register of the farm (6) electricity data, and management of this electricity data;
a measurer for exceeding electricity that the farm (6) generates and the measure of amount of electricity that returns to the grid, it has to be measured.
a module for communication with the power distribution (9);
a module for communication with a technical center, that can management the distribution of electricity, based on the monitoring of the production and quality of this electricity.
a bus for communication and translation of data. This bus is important because it is the responsible to pattern the received data, and create an intelligent database.

The exceeding electricity has to be aligned in order to contribute with the database, which in an embodiment it can be a data cube and intelligence of the system, therefore it is necessary integrate investors in the panel and organize this data. But there are so many types of investors in the market, and each one generates its own type of data, in an embodiment, in order to make this data uniform the bus for communication and translation is necessary.

Besides the fact that this generation control equipment (5) has to be integrated with the information control device (4), it is not necessary that the data collected goes to the access interface (7). Which allows the system to give the possibility to the properties of farms to contract the service in the generation control equipment (5), without participate of the access interface (7). However, at the same time they help the system, giving information about the electricity generation in the information control device (4) expanding the database, but the electricity generate by them cannot be redistribute for the others agents of the system.

The access interface (7) comprises:
a module for user interface, that can be, in an embodiment a web interface;
a module for administration of the consumer unity, where happens the register and maintenance of information about the participants of the access interface;
a module for energy quota, that allows the participant change your quota plan;
a module for payment, that allows the participant to control your history payments;
a converter of exceeding energy in credits, this tool is responsible to convert the valor of the money the participant pays for be in the system with the valor of the exceeding electricity that he/she generates. Making both, one unique exchange trade.

In a second aspect, the present invention proposes a method for processing a consumer data in electrical grids, where said electrical grids comprise at least a data collector in communication with a central system manager, wherein such method comprises the steps of:
collecting data in an electrical grid by the data collector;
sending collected consumer data to the central system manager;
processing collected consumer data, generating a consumer profile.

In an embodiment, the step of processing collected consumer data comprises an analysis of electrical consumption of a consumer by verifying electrical equipment consumption. In an embodiment, the data collector performs an analysis of the consumption/generation of each equipment independently of the consumer. In further embodiment, the data collector performs an analysis of the harmonics generated by each equipment of the consumer. The collected data is therefore sent to the central system manager allowing the processing of such data.

In an embodiment, the consumer is also provided with an electricity generator having a generation rate, in such a way that the data collector identifies the generation rate and is able to identify divergences from an expected generation rate. In an embodiment, a consumer comprises a plurality of frequency inverters and the central system manager integrates the commands of the plurality of frequency inverters in a single interface. In a further embodiment, the central system manager comprises a scraping algorithm for integrating a plurality of frequency inverters.

Based on the collected consumer data, the central system manager is able to processing said data and generating a consumer profile. In an embodiment, the generation of a consumer profile is performed by a computer in which is implemented the central system manager. As can be seen, the profile is provided based on the power consumption and it allows creating a business plan and economic strategies for the consumer. In an embodiment, the central system manager comprises tools of business intelligence and artificial intelligence. In an embodiment, the central system manager comprises a tool for integration to electrical equipment manufacturers providing the consumer's data and further analysis of the power consumption of said equipment.

In an embodiment, the proposed method comprises the steps as detailed below:

Management and Analysis of Generated Electricity

In this step occurs: the generation of electricity, the management of generated energy and the analysis of generated energy. In an embodiment, the electricity energy can be generated by at least a microgenerator, in the micro farm (1), or in a generator, in the farm (6). Said micro farm (1) and farm (6) are detailed above. After this, here the electricity generated is managed in two different ways.

In an embodiment for the micro generator, the hardware (2) of the data collector collects the electricity energy and it is able to: read how the electricity is being consumed, what is the origin of this electricity and send this information collected to the software (3) implemented in the hardware (2).

In present invention is possible to install equipment with the purpose to make a micro generation station in the residence of the future users of the system. The hardware (2) is installed alongside with the device that is able to generate electricity where, in an embodiment, such device can be a solar panel, or wind turbine or any other device that can gather electricity. The hardware (2) is able to manage the microgeneration, storage and consume of the electrical installation. So with this hardware (2) an analysis of performance includes the information about what is generated and information about what is consumed. After, this information is sent to the software (3).

Besides that, the hardware (2) is able to recognize the consume signatures, that is, can absorb information about how the energy is being consumed and this information goes to the software (3) to be part of the database.

In an embodiment the software (3) has a visual interface where the users can gather information about the quality and efficiency of their microgeneration.

The farm (6) is operably associated with a generation control equipment (5), where said generation control equipment (5) is similar to the data collector described above. Where this equipment has the responsibility to interact with the generator and inform to the information control device (4) what is going on. The electricity producers that want become members to pass through a viability process, which also is a responsibility of this product. So, this product is able to: register and manage data from the farm (6) and measure the quantity of electricity given to the grid. The exceeding electricity must be measured in several criteria and has to be aligned with other information like climate conditions, local of the solar panels etc., because of this other information we can increase our database and intelligence of our system.

In an embodiment for the making of these measures it is necessary to integrate the various investors in the solar panels, and unify all this information. Since, there are many types of investors in the market, there are many different technologies. Each technology delivers different information or information out of pattern. Thus, to contribute for the database, it is necessary to have a bus for communication and translation of data.

The farm (1) has access to a decision-making technical center. This center has the capacity to distribute and deliver electricity, based in the production monitoring and in the quality of the electricity.

Consolidation of Electricity Data

This step comprises the results of the step described above. The software (3) is able to organize all information gathered about the microgeneration and deliver all in electricity data. As defined by the software for microgeneration, the generation control equipment (5) also sends your gathered information about the farms (6) and delivers electricity data. This both electricity data are directed to the information control device (4) where occurs the presenting consolidation of electricity data.

At the information control device (4), the electricity data is gathered and put together generating the valuable database. This data is processed and in an embodiment the database comprises a data cube that is able to storage this electricity data, and other type of data, in a security and confidential way.

So with this huge database now the system is able to help operators in decision-making. The user's installation comprehends: the hardware (2), the software (3) and the generation control equipment (5), these three items are able to capture the electricity data, and the information control device (4) generates insights/alerts of deviations in consume or production patterns through. In an embodiment it is possible to know if a home appliance of the user is not working properly by the using of this system, more precisely using the database.

In an embodiment, the central system manager uses the database and the consumer profile to generate discounts on the consumer's bill or grant the consumer with credits that can be used to buy equipment or services.

Sending the Electricity Data to the Accessed Interface (7)

The users of this system have to be registered, and this registration happens in the accessed interface (7) where it is able to do the maintenance of information of the electrical grid of a user (8). So the user is able to change your information, change your quota plan and maintain your control of historic payments.

To participate in this interface it is necessary to pass through a viability study, which investigate if the farm (6) or micro farm (1), is located in a place nearby a registered power distribution (9). For exemplary purposes, the owner of the system can charge a fee of a client who wants to become a member of this access interface (7), where said client can be a person or a company.

The control of the payment of electricity is a responsibility of the access interface (7) and after a time of paying correctly the electricity bills, the participant receives proportionally discounts in his/her bill just by being in the system and paying correctly the bills.

The Communication with the Storage Data Element (10)

The database created by this system is a valuable product that it can deliver, since the information that it has can be very helpful in decision-making for some third parties and for the users of the system.

In an embodiment, the storage data element (10) refers to any means to transfer and store data and to provide an external access to interested companies. The database contained in the information control device (4) is something very important for a company that wants to know about the malfunction of a device, for example. Giving the access of this data to the company can help them to improve their products, fixing the aspects that are making the product does not work well, and this fact can improve this product. As can be seen, even a company that is not enrolled by the present invention can benefit from it. So everybody that participates and don't participate (an external company, for example) in the system wins. Because the product is improved, so the consumers have a product that failure less and do not waste too much energy, and the company has an improved product to sell.

Example of implementation of the system described above:

Clube Watt: Solution Architecture

Project dictionary:

UI: User interface

CU: Consumer Unity

PP: Physical Person

LP: Legal Person

CISC: Control and Intelligence Strategic Center

CGC: Control of Generation Center

ECM: Electricity Control & Management

HW: Hardware

SW: Software

In an embodiment of the present invention, the project comprehends the following actors:
PP and LP clients: the system attends the two types. It is expect that a family and a company can produce electricity and return the exceeding to the grid. Saving money in the bills.
Micro farm (1) (AC Module): Local and domestic electricity generation. Mostly, it is the electricity production in photovoltaic panel method.
Farm (6): Places where the electricity generation has the production limit, in an embodiment, of 5 MW. Mostly, it is covered areas with photovoltaic panel, like roofs.
Partner companies: As soon as the portal gains the knowledge of how the electricity is being consumed by your associates, it is possible to make commercial partnerships with companies. For example, to create a consumer list that is using old models of fridges and offer new and economic models. Thus, we creates a consume economy to the associates and more business to our partners.
Power Distribution (9): Companies that have the responsibility to distribute the exceeding electricity generated by the farms of the club or by power plants.

Products and yours methods: List of products that comprises the solution or that can be commercialized individually. Each item has a brief description of your comprised modules.

ECM Hardware

In this invention is possible to install equipment with the purpose to make a micro generation station in the residence of the future users of the system. The hardware (2) is installed together with the device that is able to generate electricity; in an embodiment this device can be a solar panel, or wind turbine or any other device that can gather electricity. The hardware (2) is able to manage the microgeneration, storage and consume of the electrical installation. So with this hardware an analysis of performance include the information about what is generated and information about what is consumed. After, this information is sent to the software (3), in this embodiment the ECM Software.

Besides that, the hardware (2) is able to recognize the consume signatures, that is, can absorb information about how the energy is being consumed and this information goes to the software (3) to be part of the database, improving the intelligence of the club. Hence, this hardware can offer this benefit for the consumers that can know how their energy is being consumed. This ECM Hardware comprises:
a module for consume identification, that can read data about the electricity that is being consumed;
a module for consume control, that can give the origin of the electricity generation. If it is from a power distribution (9) or propriety generation;
a module for communication, that can send all that data to the software (3) implementation, in this embodiment the ECM Software.

ECM Software

This Software is able to interact with the ECM HW (by the communication module) or with other similar market devices and so transmit this information to CISC (communication module CISC) for the data consolidation.

This product also has a visual interface (UI module) where the clients can acquire the information in a simple way about the quality and efficiency of their microgeneration.

Once the access interface (7) that in an embodiment can be a web club called ClubeWatt, knows how the electricity of its associates is being consumed, the group has inputs to create commercial partnerships with market companies. It is possible to suggest the change of old home appliance for a new one that consumes less electricity. Thus, offering advantage for the consumer and for the partner.

CISC

In the information control device (4), which in this embodiment is the CISC, the electricity data collected is consolidated in a database. And this device is able to help operators to make strategy and commercial decisions. This device comprises:
a module for communication with ECM, that can gather data from the micro farm (1) and data from patterns of consume from the consumers of electricity (CU). That is, this module communicates with the software (3) implementation, ECM Software;
a data cube module. Able to store the data in a security and confidential way. And at the same time, can generate reports that can help in decision-making. In an embodiment, database is a module data cube;
a module for communication with an access interface (7), in this embodiment is the portal ClubeWatt, this may be any place where data can be managed. At the beginning, the present invention has your own portal (ClubeWatt) that can display the data. But this cannot be a restriction; because this database can be used to any other portals that may eventually want this data;
A BI and AI module, able to creates insight/warning about the deviation in consume and production patterns.

ClubeWatt Portal

This portal is an embodiment of the access interface (7). It is a web interface (UI module) where happens the register and maintenance of CU information (CU Administrator module). Therefore, in this portal is possible to the consumer sign up, change his information, change his quota plan (electricity quota module) and maintain the control of his payments history (Payment module).

The CU that has the interest to participate in the ClubeWatt has to pass through a viability study, seen that can participate only the CUs that belong to the covered action area of power distribution (9).

In case the client is in an action area of the club, he can pay an inscription fee. This fee is necessary to cover the costs for the entrance in the club. In an embodiment, said fee for a user that is covered by an area of power distribution (9) may vary for physical person (PP) and legal person (LP). This fee covers the costs of entrance in the system.

For a user that is not covered by an area of power distribution (9) he can pay a pre-inscription fee costs varying for physical person and for legal person. This fee demonstrates the interest in participate in the club and its payment exempt the inscription fee, in case the client's area become an action area. After one year and the area have not being covered the client may ask for a refund.

The club operates with a virtual currency in despite of real money. So, the quotas that must be paid monthly is convert in a type of credits called Eletrocoins, and the exceeding of electricity that returns to the grid, also is converted in Eletrocoins. The user can follow his balance wallet of Eletrocoin, so he can predict his electricity expenditure.

In an embodiment, FIG. 2 presents a graph that illustrates how this discount process works. The user counts with an increase in his discount at each year that he has maximum one delayed bill to pay. So the graph shows the discount for an user that maintain his bills paid on time, as can be seen, the discount can reach 100 percent, that is, after 15 years participating in the system is possible pay no more bills. It is the responsibility of this module the control of this discount policy that each client has. Besides the fact, that this module has to inform to the client what is his discount band and alert for late payment.

CGC

Companies located in a good solar exposition area can participate in the club like electricity producers. These companies can sign up for free and they can profit with the exceeding of electricity produced.

Similarly to ECM, this product CGC is an embodiment for the generation control equipment (5), and has the responsibility to interact with the production source and inform CISC about what is going on.

As in the CU management module, the producers of electricity that want to participate in the ClubeWatt need to pass through a register step and through a viability study. This module administrates this process.

In this product CISC is possible to:
Register and manage the farm (6) data (register of farm module);
Measure the quantity of electricity that is returning to the grid (communication with the power distribution (9) module)

The exceeding electricity that returns to grid must be measured in several criteria and aligned to other information (like climate condition, panel local and others) to contribute to the data cube and club intelligence. Thus, it is necessary integrate the various investors in the solar panels, and unify all this information. Since, there are many types of investors in the market, there are many different technologies. Each technology delivers different information or information out of pattern. Therefore, to contribute for the cube data it is necessary to have a bus for communication and translation of data.

The farm (1) has access to a decision-making technical center that in an embodiment is called Virtual Power Plant control. This center has the capacity to distribute and deliver electricity, based in the production monitoring and in the quality of the electricity.

The farm owners can contract the CGC software like a service, without being a member of ClubeWatt. So, the information about the electricity generation continues to be shared with CISC, but the electricity is not redistributed to others CUs.

What is claimed is:

1. A system for processing consumer data in electrical grids, the system comprising:
a data collector installed in the electrical grid that perform a monitoring of power consumption/generation on a consumer electrical grid, identifying consume of a consumer equipment and send the consumer data to a central system manager; and
the central system manager processes the data acquired by the data collector and generates an consumer profile, wherein the consumer profile is used to generate benefits to the consumer.

2. The system according to claim 1, wherein the data collector collects data from at least one electricity generator.

3. The system according to claim 1, wherein the central system manager integrates a plurality of frequency inverters of different producer by a single interface.

4. The system according to claim 3, wherein the central system manager comprises a scraping algorithm for integrating a plurality of frequency inverters.

5. A method for processing consumer data in electrical grids, wherein said electrical grids comprises at least a data collector in communication with a central system manager, wherein said method comprises the steps of:
a) collecting the consumer data in an electrical grid by the data collector;
b) sending collected consumer data to the central system manager; and
c) processing collected consumer data, generating a consumer profile.

6. The method according to claim 5, wherein the step of processing collected consumer data comprises an analysis of electrical consumption of a consumer by verifying electrical equipment consumption.

7. The method according to claim 5, further comprising a step of generating consumer benefits based on the consumer profile.

8. The method according to claim 5, wherein the electrical grid comprises at least one generator having a generation rate, in such a way that the data collector identifies the generation rate and identifies divergences from an expected generation rate.

9. The method according to claim 5, wherein a consumer comprises a plurality of frequency inverters and the central system manager integrates the commands of the plurality of frequency inverters in a single interface.

10. The method according to claim 9, wherein the central system manager comprises a scraping algorithm for integrating a plurality of frequency inverters.

11. A system for operating consumer data in electrical grids comprising:
a micro farm (1) electricity generator;
a data collector comprising:
at least one hardware (2) for data collection; and
at least one software implementation (3) for data collection;
wherein the at least one software implementation (3) is implemented in the at least one hardware (2);
an information control device (4);
a generation control equipment (5);
a farm (6) electricity generator; and
an access interface (7);
wherein the hardware (2) of the data collector further comprises a module for consume identification and a module for consume control, and
wherein the access interface (7) comprises at least one of: a module for user interface; a module for administration of the consumer unity; a module for energy quota; a module for payment; and/or a converter of exceeding electricity in energy credits.

12. A method for operating consumer data in electrical grids, comprising the steps of:
a) collecting the consumer data in an electrical grid by the data collector;
b) sending collected consumer data to the central system manager; and
c) processing collected consumer data, generating a consumer profile,
wherein said steps are implemented in a system comprising:
a micro farm (1) electricity generator;
a data collector comprising:
at least one hardware (2) for data collection; and
at least one software implementation (3) for data collection;
wherein the at least one software implementation (3) is implemented in the at least one hardware (2);
an information control device (4);
a generation control equipment (5);
a farm (6) electricity generator; and
an access interface (7);
wherein the hardware (2) of the data collector further comprises a module for consume identification and a module for consume control, and
wherein the access interface (7) comprises at least one of: a module for user interface; a module for administration of the consumer unity; a module for energy quota; a module for payment; and/or a converter of exceeding electricity in energy credits.
